(19) United States
(12) Patent Application Publication
(10) Pub. No.: US 2013/0204534 A1
(43) Pub. Date: Aug. 8, 2013

(54) Method Of Estimating A Subterranean Formation Property

(71) Applicant: SCHLUMBERGER TECHNOLOGY CORPORATION, Sugar Land, TX (US)

(72) Inventors: Vivek Anand, Meerut (IN); Robert Freedman, Houston, TX (US); Chanh Cao Minh, Katy, TX (US)

(73) Assignee: SCHLUMBERGER TECHNOLOGY CORPORATION, Sugar Land, TX (US)

(21) Appl. No.: 13/749,455

(22) Filed: Jan. 24, 2013

Related U.S. Application Data
(60) Provisional application No. 61/591,625, filed on Jan. 27, 2012.

(51) Int. Cl. G06F 17/15; G01V 9/00

(52) U.S. Cl. CPC G06F 17/15; G01V 9/00
USPC 702/11

(57) ABSTRACT

A method of analyzing a subterranean formation may include collecting a plurality of tool responses from different tools and generating a respective theoretical equation relating tool responses for each of the tools to properties of the subterranean formation. The method may also include generating a database having the tool responses stored therein based upon each respective theoretical equation and generating a non-linear mapping function relating at least one of the tool responses to at least one property of the subterranean formation. The method may also include estimating a value for the at least one property based upon the non-linear mapping function.

### CROSS-REFERENCE TO RELATED APPLICATION

This application claims the benefit of a related U.S. Provisional Application Ser. No. 61/591,625, filed Jan. 27, 2012, entitled “METHOD FOR MULTI-TOOL OR MULTI-MEASUREMENT INTERPRETATION FOR PREDICTION OF FORMATION PROPERTIES,” the disclosure of which is incorporated by reference herein in its entirety.

### BACKGROUND

During well logging, a set of measurements may be acquired as a function of borehole depth, for example. Following acquisition, the measurements may be preprocessed by algorithms to account for tool calibration, borehole effects, etc. The preprocessed measurements may then be interpreted using petrophysical data interpretation techniques for predicting subterranean formation properties.

A problem associated with log interpretation may be the inverse problem wherein the properties of an underlying system are estimated from a suite of measurements. Theoretical models may be used to relate the properties of the system to the measurements. Such theoretical equations include Archie's equation, the Waxman-Smits model, the dual water model, the Timur-Coates equation, and the CRIM model, for example. Considering a set of n independent log measurements and a corresponding set of n theoretical response equations which depend on a set of m unknown reservoir properties, the inverse problem involves estimating m formation properties from a set of n coupled equations.

Several factors contribute to the difficulties encountered in addressing such an inverse problem. First, the theoretical equations are, in most cases, nonlinear and thus may not be solved analytically. Second, for the results to be consistent with measurements, the equations are simultaneously solved. Additionally, the number of equations may not be equal to the number of unknowns, and the acceptable approaches should obey physical constraints, e.g. water saturation of the formation is constrained between 0 and 1.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method of analyzing a subterranean formation may include collecting a plurality of tool responses from different tools and generating a respective theoretical equation relating tool responses for each of the tools to properties of the subterranean formation. The method may also include generating a database having the tool responses stored therein based upon each respective theoretical equation and generating a non-linear mapping function relating at least one of the tool responses to at least one property of the subterranean formation. The method may also include estimating a value for the at least one property based upon the non-linear mapping function.

A non-transitory computer-readable medium for analyzing a subterranean formation may include computer-executable instructions. The computer-executable instructions may be for collecting a plurality of tool responses from a plurality of different tools and generating a respective theoretical equation relating tool responses for each of the tools to a plurality of properties of the subterranean formation. The computer-executable instructions may also be for generating a database having the tool responses stored therein based upon each respective theoretical equation, and generating a non-linear mapping function relating at least one of the tool responses to at least one property of the subterranean formation. The computer-executable instructions may also be for estimating a value for the at least one property based upon the non-linear mapping function.

### BRIEF DESCRIPTION OF THE DRAWINGS

FIG. 1 is a schematic diagram of a subterranean a well logging system for use with a method in accordance with an embodiment.

FIG. 2 is a flowchart of a method of analyzing a subterranean formation in accordance with an embodiment.

FIG. 3 is a diagram illustrating the division of a database and application of a mapping function in accordance with an embodiment.

FIG. 4 is a graph of estimated water saturation values estimated using a method in accordance with an embodiment.

FIG. 5 is a graph of estimated water salinity values estimated using a method in accordance with an embodiment.

FIG. 6 is a graph comparing water saturation using a method in accordance with an embodiment.

FIG. 7 is a graph comparing water salinity using a method in accordance with an embodiment.

FIG. 8 is a graph of solution space for a joint interpretation of resistivity and sigma measurements according to an embodiment.

FIG. 9 is a graph comparing estimated water saturation values estimated according to an embodiment with true specified values.

FIG. 10 is a graph comparing estimated water salinity values estimated according to an embodiment with true specified values.

FIG. 11 is a graph comparing estimated values of Archie's cementation exponent estimated according to an embodiment with true specified values.

FIG. 12 is a graph of solution space showing surfaces for m=1 according to an embodiment.

FIG. 13 is a graph of solution space showing surfaces for m=2 according to an embodiment.

FIG. 14 is a graph of solution space showing surfaces for m=3 according to an embodiment.

FIG. 15 is a graph comparing sand resistivities estimated according to an embodiment with database values.

FIG. 16 is a graph comparing shale resistivities estimated according to an embodiment with database values.

FIG. 17 is another graph comparing sand resistivities estimated according to an embodiment with database values.

FIG. 18 is another graph comparing sand resistivities estimated according to an embodiment with database values.

FIG. 19 is a graph of solution space showing contour lines of R_{sand} and Fₛₕ according to an embodiment.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

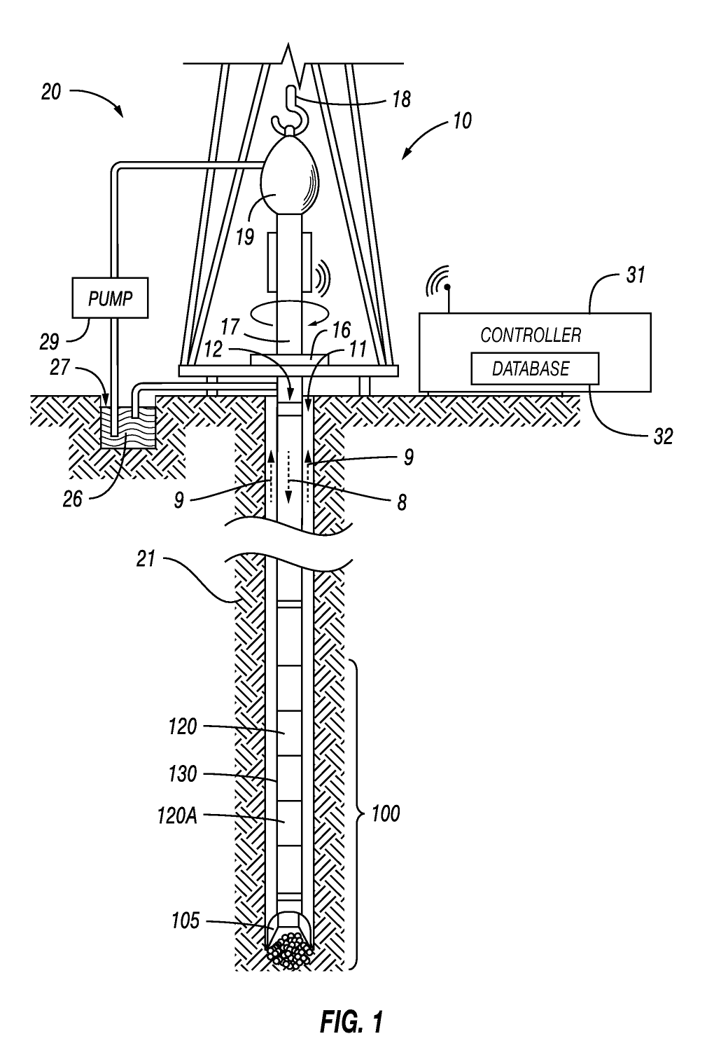

Referring initially to FIG. 1, a well site system 20 in is illustrated. The wellsite system 20 may be onshore or offshore, for example. A borehole 11 is formed in a subterranean formation 21, for example, by rotary drilling. Of course, the borehole 11 may be formed in the subterranean formation 21 using other techniques, for example, directional drilling.

A drill string 12 is suspended within the borehole 11 and has a bottom hole assembly 100 which includes a drill bit 105 at its lower end. The system 20 includes a platform and derrick assembly 10 positioned over the borehole 11. The assembly 10 includes a rotary table 16, a kelly 17, a hook 18, and a rotary swivel 19. The drill string 12 is rotated by the rotary table 16 and energized to engage the kelly 17 at the upper end of the drill string. The drill string 12 is suspended from the hook 18, attached to a traveling block, through the kelly 17 and the rotary swivel 19 which permits rotation of the drill string relative to the hook. A top drive system could alternatively be used.

Drilling fluid or mud 26 may be stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole 11, as indicated by the directional arrows 9. The drilling fluid lubricates the drill bit 105 and carries subterranean formation cuttings to the surface to be returned to the pit 27 for recirculation.

The bottom hole assembly 100 includes a logging-while-drilling (LWD) module 120, a measuring-while-drilling (MWD) module 130, a roto-steerable system and motor, and drill bit 105. The LWD module 120 is carried by a drill collar and may include one or more logging tools. Of course, more than one LWD and/or MWD module may be used, for example, as illustrated. It should be noted that references made herein to a module at the position 120 may alternatively correspond to a module at the position of 120A. The LWD module 120 includes capabilities for measuring, processing, and storing information, and for communicating with the surface equipment. The LWD module 120 may include a directional resistivity measuring device.

The MWD module 130 is also carried by a drill collar, and may include one or more devices for measuring characteristics of the drill string and drill bit. The MWD tool or module 130 may further include a device for generating electrical power to the downhole system, for example, a mud turbine generator powered by the flow of the drilling fluid. Of course, other types of power and/or battery systems may be used. The MWD module 130 may include one or more of the following types of measuring devices: a weight-on-bit measuring device, a torque measuring device, a vibration measuring device, a shock measuring device, a stick slip measuring device, a direction measuring device, and an inclination measuring device.

Measurements from the measuring devices of the LWD and/or MWD modules 120, 130 may be sent, for example, wirelessly via wireless communications circuitry, to the surface for processing. For example, a controller 31 may control and log the measurements. The controller 31 may be in the form of one or more processors and a memory coupled thereto, and includes a database 32.

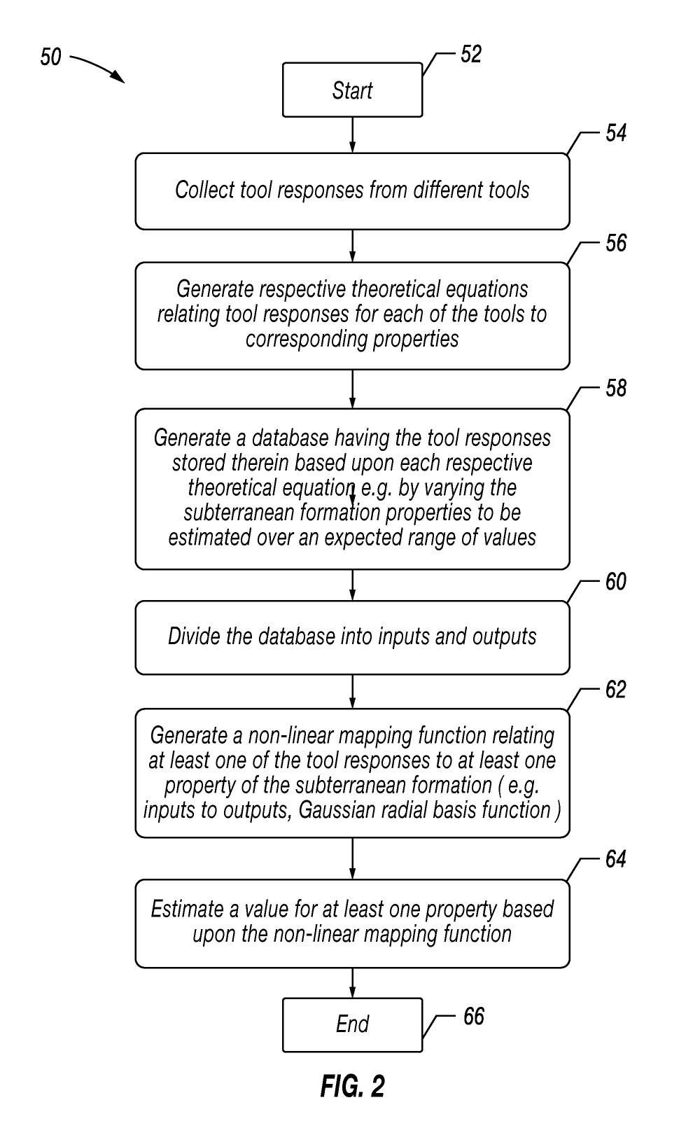

Referring now additionally to the flowchart 50 in FIG. 2, beginning at Block 52, a method of analyzing the subterranean formation 21, and more particularly, interpreting the measurements made by downhole tools, for example, the LWD and/or MWD modules 120, 130 to evaluate the subterranean formation is now described.

However, before describing the details of the method, it may be particularly helpful to describe the underlying concepts of the method. For example, the inversion used herein is described in U.S. Pat. No. 7,309,983 to Freedman, the entire contents of which are herein incorporated by reference, as a method for solving relatively complex reservoir characterization problems. This inversion technique, however, does not involve fitting the log measurements to the tool response equations, for example:

$$E ( \vec{r} , s ) = {\sum }_{i = 1}^{n} {W ( σ ( {d}_{i} , s ) ) [ {d}_{i} ( s ) - {R}_{i} ( \vec{r} , s ) ]}^{2}$$

The technique described in the Freedman '983 patent reduced the problems of non-linear minimization, such as, for example, how to accurately determine weighting factors.

This technique was used as a basis for the method described herein, which includes collecting tool responses from different tools (Block 54), for example, as described above. The method also includes generating a respective theoretical equation relating tool responses for each of the tools to corresponding properties of the subterranean formation (Block 56).

The method includes generating a database 32 having the tool responses stored therein based upon each respective theoretical equation (Block 58). The database is generated by varying the subterranean formation properties to be estimated over an expected range of values. Thus, the database 32 is generated to have samples that are the tool responses and corresponding subterranean formation properties that produced those tool responses. The database 32 may be generated such that the subterranean formation properties satisfy physical constraints. Additionally, fixed parameters and constants in the models may be specified.

The database 32 may be divided into inputs and outputs (Block 60). The inputs include the tool responses while the outputs include the properties of the subterranean formation 21 to be estimated. The construction of the database 32 is discussed more explicitly below.

The method also includes generating a non-linear mapping function relating at least one of the tool responses to at least one property of the subterranean formation 21 (Block 62). More particularly, the non-linear mapping function relates the database inputs and outputs. The non-linear mapping function may include a linear combination of at least one radial basis function, for example, a Gaussian radial basis function. The Gaussian radial basis function may be determined based upon adjacent ones of the tool responses stored in the database 32. Additionally, the coefficients of the non-linear mapping function may be generated uniquely and non-iteratively using the database 32.

In other words, the database 32 is used to derive the non-linear mapping function, which is then used to estimate the properties of the subterranean formation 21. More particularly, the non-linear mapping function is a function of the tool measurements and has an output value that represents an estimated property of the subterranean formation 21. At least some of the tool responses stored in the database 32 may be displayed in multiple dimensions for at least one property of the subterranean formation 21.

The well logging inverse problem is addressed by using the mapping function \vec{F} because

\vec{F}(d₁,d₂, . . . , dₙ)=\vec{r}*≡(φ,S_{w},Sₓₒ,Vₛₕ, . . . )^{T},

where dᵢ is the i-th measurement with n measurements and \vec{r}* is a vector whose components are the estimated subterranean formation properties. The inversion method described in the Freedman '983 patent provides the methodology for deriving the mapping function above. As will be described in greater detail below, \vec{F} can be expressed as a linear combination of Gaussian radial basis functions (RBFs) whose coefficients can be uniquely computed from the database.

The method further includes estimating a value for the at least one property based upon the non-linear mapping function (Block 64). The estimated value may be estimated to be consistent with the respective theoretical equation and the corresponding tool responses. The method ends at Block 66.

Consider a simple shale model, for example, noting the same concepts and techniques may apply to more complex subterranean formations with additional numbers and types of tool measurements. For the simple shale model consider the measurements of subterranean formation bulk density (ρ_{b}), neutron porosity (φ_{N}), formation resistivity (Rₜ), and flushed zone resistivity (Rₓₒ) and gamma-ray (GR). It is assumed that borehole and thin-bed corrections, etc. have been applied to the raw tool measurements. The response equations for these measurements are functions of the subterranean formation properties to be determined For the relatively simple shaly sand example, the subterranean formation properties to be determined may be the effective formation porosity (φ), the volume of shale (Vₛₕ), the undisturbed formation water saturation (S_{w}), and the flushed zone water saturation (Sₓₒ).

The theoretical response equations for the above measurements are functions of the subterranean formation properties. For example, if an overhead tilde is used to distinguish response equations from actual measurements, then the subterranean formation resistivity response equation can be written as \tilde{R}ₜ(φ,Vₛₕ,S_{w};R_{w},Rₛₕ,m,n) which is a function of three of the subterranean formation properties to be estimated. It also depends parametrically on the subterranean formation water resistivity (R_{w}), saturation (n) and cementation (m) exponents, and the shale resistivity (Rₛₕ). These are fixed well zone parameters that may be input by a log analyst, for example. Similarly, theoretical response equations can be written for \tilde{R}ₓₒ, \tilde{φ}_{N}, \tilde{ρ}_{B}, and for the gamma-ray response. The latter response equations are functions of one or more of the subterranean formation properties to be estimated and also depend parametrically on various zone parameters.

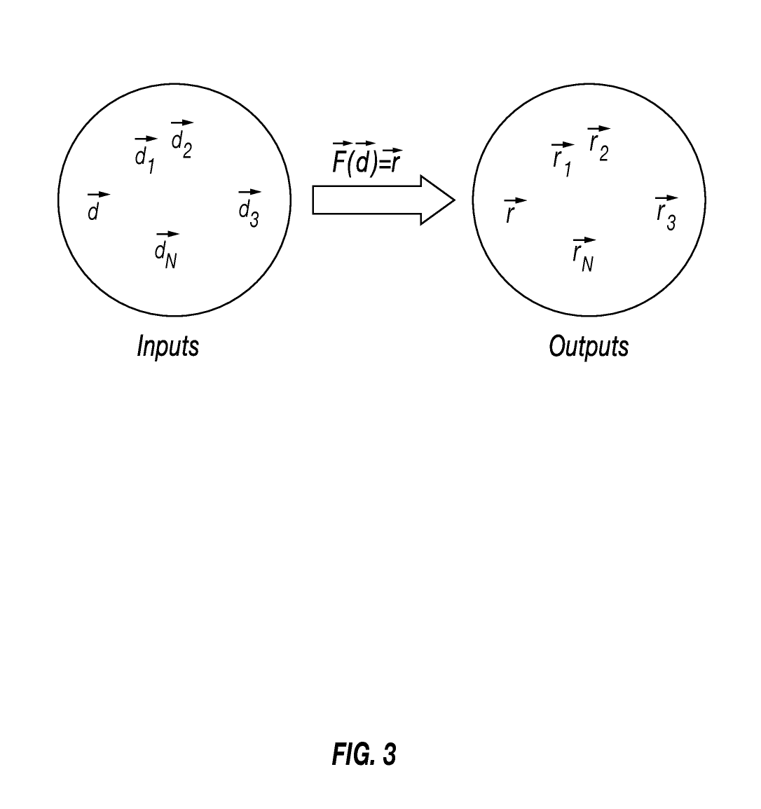

FIG. 3 illustrates that concept of a database with N samples being computed from the tool response equations and divided into inputs and outputs. A mapping function \vec{F}(\vec{d}) is computed from the database. The mapping function outputs the reservoir properties (\vec{r}*) given a suite of logging measurements (\vec{d}). The mathematical formulation of the above-described method or interpolation technique will now be described in greater detail. Let \vec{f}(\vec{x}),\vec{x}∈ [symbol] ⁿ and \vec{f}∈ [symbol] ^{m} be a real-valued vector function of n variables, and let values of \vec{f}(\vec{xᵢ})=\vec{yᵢ} be given at N distinct points, \vec{xᵢ}. The interpolation problem is to construct the function \vec{F}(\vec{x}) that approximates \vec{f}(\vec{x}) and satisfies the interpolation equations:

\vec{F}(\vec{xᵢ})=\vec{yᵢ}, i=1, 2, . . . N (1)

The interpolation function can be constructed as a linear combination of radial basis functions (RBFs) given as:

$$\vec{F} ( \vec{{x}_{i}} ) = {\sum }_{i = 1}^{N} \vec{{c}_{i}} ϕ ( ‖ \vec{x} - \vec{{x}_{i}} ‖ ) , i = 1 , 2 … N \qquad ( 2 )$$

The functions φ(∥\vec{x}−\vec{xᵢ}∥) are called “radial” because the argument of the function depends on the distance between, not the direction, of \vec{xᵢ}, from an arbitrary input vector at which the function is to be evaluated. The argument is given by the Euclidean norm in the n-dimensional hyper space. The coefficients \vec{cᵢ} can be calculated by satisfaction of the interpolation equations. Thus, the coefficients are given as:

C=Φ⁻¹·Y (3)

where C is the matrix whose rows include the coefficient vectors i.e.

$$C = [ \begin{matrix}{c}_{1 , 1} & {c}_{1 , 2} & … & {c}_{1 , m} \\ {c}_{2 , 1} & {c}_{2 , 2} & … & {c}_{2 , m} \\ ⋮ & ⋮ & ⋮ & ⋮ \\ ⋮ & ⋮ & ⋮ & ⋮ \\ {c}_{N , 1} & {c}_{N , 2} & … & {c}_{N , m}\end{matrix} ] \qquad ( 4 )$$

The matrices Y and Φ are the N×N and N×m matrices including the RBF and data vectors given as:

$$\begin{matrix}Φ = [ \begin{matrix}{ϕ}_{1 , 1} & {ϕ}_{1 , 2} & … & {ϕ}_{1 , N} \\ {ϕ}_{2 , 1} & {ϕ}_{2 , 2} & … & {ϕ}_{2 , N} \\ ⋮ & ⋮ & ⋮ & ⋮ \\ ⋮ & ⋮ & ⋮ & ⋮ \\ {ϕ}_{N , 1} & {ϕ}_{N , 2} & … & {ϕ}_{N , N}\end{matrix} ] & ( 5 ) \\ Y = [ \begin{matrix}{y}_{1 , 1} & {y}_{1 , 2} & … & {y}_{1 , m} \\ {y}_{2 , 1} & {y}_{2 , 2} & … & {y}_{2 , m} \\ ⋮ & ⋮ & ⋮ & ⋮ \\ ⋮ & ⋮ & ⋮ & ⋮ \\ {y}_{N , 1} & {y}_{N , 2} & … & {y}_{N , m}\end{matrix} ] & ( 6 )\end{matrix}$$

It can be proved mathematically that the matrix Φ is non-singular for certain functional forms of RBFs including Gaussian, multiquadric, and inverse quadrics. This property ensures that the mapping function of Eq. (2) may be unique. The RBFs used in this disclosure are the normalized Gaussian RBFs given as:

$$ϕ ( ‖ \vec{x} - \vec{{x}_{j}} ‖ ) = \frac{exp ( - \frac{{‖ \vec{x} - \vec{{x}_{j}} ‖}^{2}}{2 {s}_{j}^{2}} )}{{\sum }_{j = 1}^{N} exp ( - \frac{{‖ \vec{x} - \vec{{x}_{j}} ‖}^{2}}{2 {s}_{j}^{2}} )} \qquad ( 7 )$$

Of course, non-Gaussian functions may also be used. Hence, using a database with N samples, a mapping function that is consistent with the measurements may be uniquely defined from the above Eq. (2). For an unknown sample, for example, not included in the database 32, the desired output \vec{y} may be obtained by evaluating the mapping function at the corresponding input \vec{x}, i.e.

\vec{y}=\vec{F}(\vec{x}) (8)

The following describes three example applications of the methodology for multi-tool or multi-measurement interpretation.

### EXAMPLE 1

A joint interpretation of resistivity and formation neutron capture cross section measurements. A combination of resistivity and neutron capture cross section (sigma) measurements may be used for predicting water saturation of water-flooded reservoirs.

Example equations governing the resistivity (Rt) and sigma (Σ) measurements are given as,

$$\begin{matrix}{R}_{t} = \frac{{aR}_{w}}{{S}_{w}^{n} {φ}^{m}} & ( 9 ) \\ Σ = ( 1 - φ ) {Σ}_{m} + φ {S}_{w} {Σ}_{w} + φ ( 1 - {S}_{w} ) {Σ}_{hc} & ( 10 )\end{matrix}$$

where φ is the formation porosity and R_{w} is the subterranean formation water resistivity. Σ, Σₘ, and Σ_{w} are subterranean formation, matrix and water sigma respectively. Water resistivity and water sigma are functions (known) of water salinity, temperature, and pressure.

To apply the methodology described herein to this example, a database of subterranean formation water saturation, water salinity, porosity, temperature (T), and pressure (P) is constructed. Note that, except for water saturation and salinity, the remainder of the quantities namely porosity, temperature, and pressure may have a single value in the database. The corresponding Rₜ and Σ responses are computed using the theoretical equations (9) and (10). The model parameters such as m, n, Σₘ and Σ_{hc} can be assumed to be known. The database is divided into inputs and outputs. The inputs include Rₜ, Σ, φ, T, and P. The outputs include water saturation and salinity. A mapping function between database inputs and outputs is constructed. The mapping function is a linear combination of Gaussian RBFs as shown below,

$$\begin{matrix}\vec{ξ} = \frac{{\sum }_{i = 1}^{N} \vec{{c}_{i}} exp ( - \frac{‖ \vec{{A}_{T}} - \vec{{A}_{T , i}} ‖}{2 {s}_{i}^{2}} )}{{\sum }_{i = 1}^{N} exp ( - \frac{‖ \vec{{A}_{T}} - \vec{{A}_{T , i}} ‖}{2 {s}_{i}^{2}} )} \\ where & ( 11 ) \\ \vec{ξ} = ( {S}_{w} , sal ) & ( 12 )\end{matrix}$$

and the input vector is given as,

\vec{A_{T}}=(Rₜ,Σ,φ,T,P) (13)

The different inputs in the input vector have different dynamic ranges and units. The inputs are thus normalized with the largest respective values in the database such that the input vector includes dimensionless numbers between 0 and 1. The widths of the Gaussian functions, s, are computed such that they are based upon, or more particularly, proportional to the nearest neighbor Euclidean distances of the inputs. The coefficients c are computed from Eq. (3). The mapping function with known coefficients can be used for estimating the water saturation and salinity of a subterranean formation from log measurements of resistivity, sigma, porosity, temperature, and pressure obtained downhole. Such an estimate is thus consistent with the log measurements, as well as the theoretical equations used to construct the database.

The accuracy of the predictions was accessed by applying the methodology to the theoretical database. A of 400 distinct combinations of water saturation and salinity was constructed. The values of water saturation were selected between 1 and a small non-zero value to ensure that the formation resistivity estimated from Eq. (9) is finite. Salinity values were selected between 10,000 ppm and 300,000 ppm. Porosity, temperature, and pressure were kept fixed. The values were φ=0.3, T=150 oF, and P=5000 psi. Water resistivity R_{w} and sigma Σ_{w} were computed for each database sample from the values of salinity, temperature, and pressure using known empirical functions. The model parameters m=2, n=2, Σₘ=10 and Σ_{hc}=20 were specified. For each combination of water saturation and salinity, corresponding resistivity of the subterranean formation and sigma were computed using Eqs (9)-(10). The database was divided into inputs including resistivity and sigma and outputs including water saturation and salinity. Note that in this case, the values of porosity, temperature, and pressure were not included in the input vector since these quantities had a single value in the database.

In some embodiments, one or more samples can be removed from the database to assess the accuracy of the predictions. In the present embodiment, one database sample was sequentially removed from the database. The mapping function of Eq. (11) was constructed between database inputs and outputs. The coefficients of the mapping function were obtained from Eq. (3) using the remaining 399 samples. The mapping function with known coefficients was used to predict the properties of the removed sample from the input measurements for this sample. The process was repeated for all samples in the database.

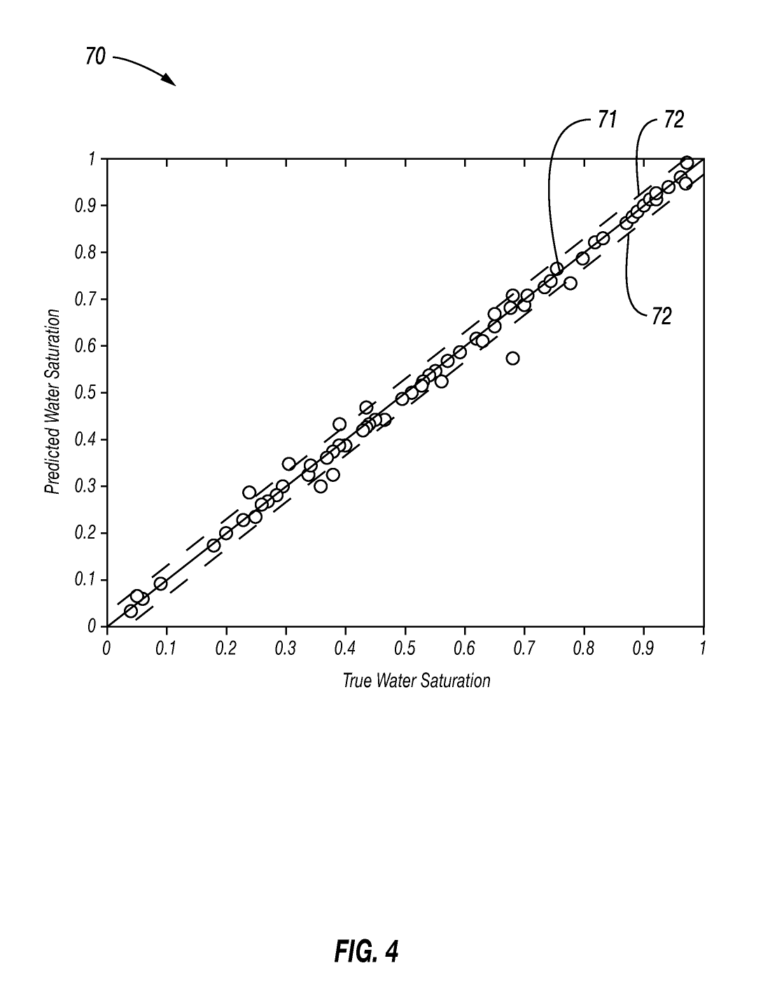

The graph 70 in FIG. 4 illustrates the comparison of the water saturation values estimated using the “leave one” technique with the database values for 80 samples in the database. In the graph 70, the solid line 71 is a best fit line and the dashed lines 72 are located at 3% deviation. Water saturation is estimated within an average relative accuracy of 2.3%.

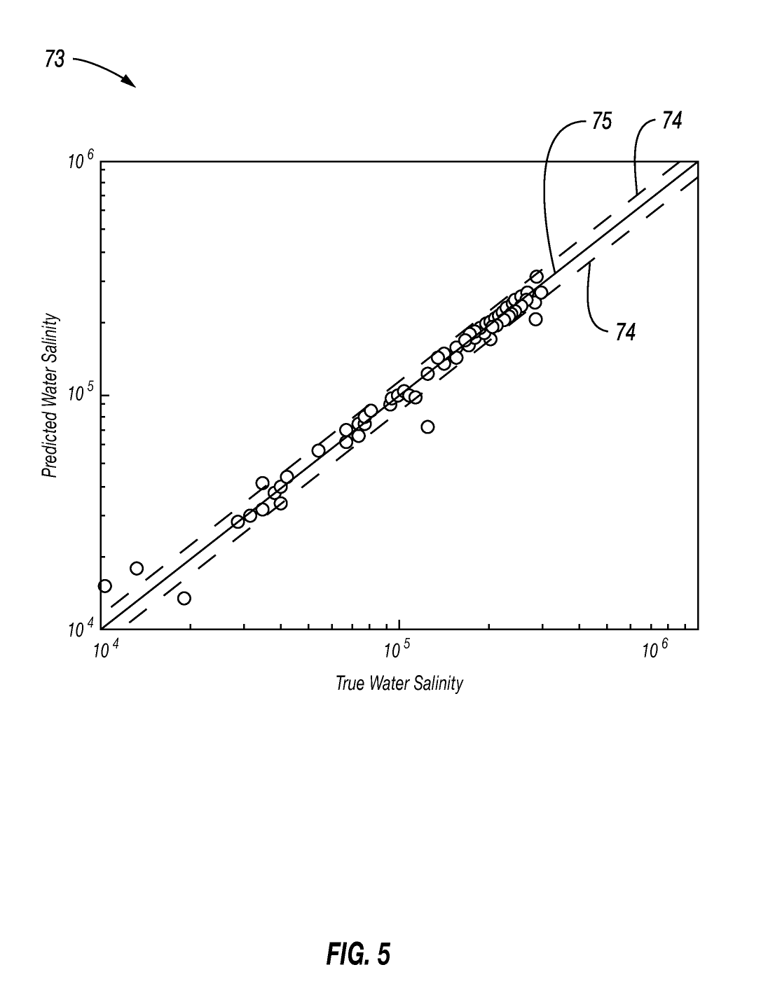

The graph 73 in FIG. 5 shows the comparison between estimated water salinity values with the database values. In the graph 73, the solid line 75 is a best fit line and the dashed lines 74 are located at 10% deviation. Salinity is estimated within an average relative accuracy of 4.4%.

The above-described technique was applied to a field example from a mature carbonate field discovered in 1950s. A water flooding project was initiated in 1970s wherein water with varying salinity had been injected to improve oil recovery. The subterranean formation water salinity is therefore, highly variable ranging from 30 ppk or less to 230 ppk. RST and SAIT logs were acquired.

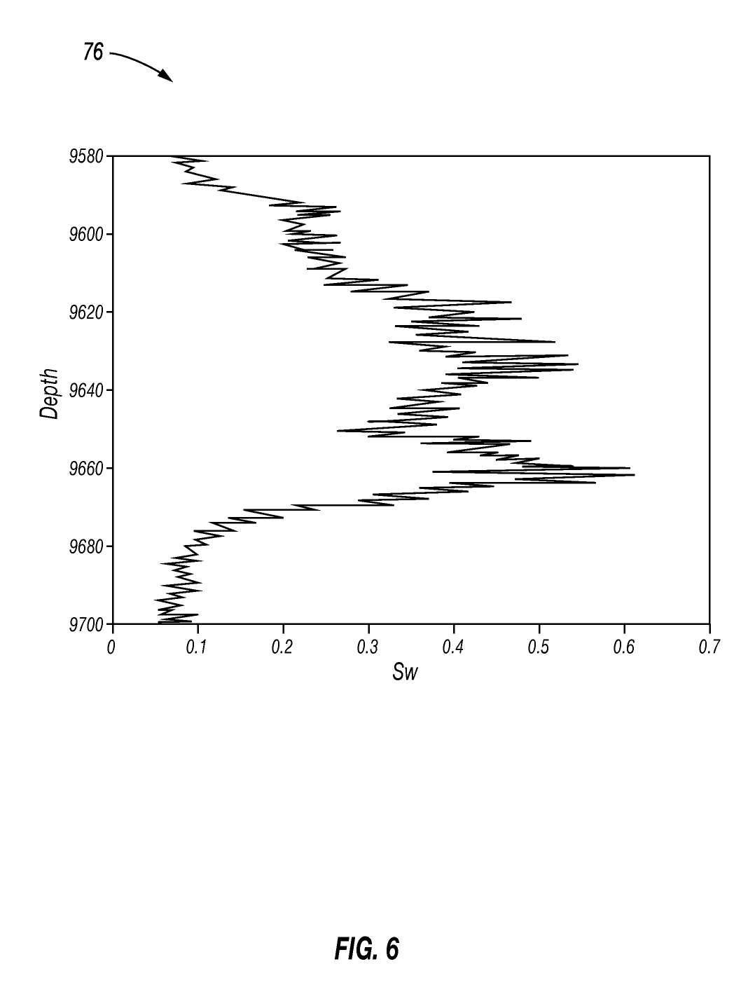

Logs of water saturation and salinity were estimated from the RBF mapping function methodology described herein according to an embodiment. At each depth, a database of 400 distinct combinations of Sw (0.001≦Sw≦1) and salinity (10⁴ ppm≦Sal≦3·10⁵ ppm) was constructed. The corresponding values of Rₜ and Σ were computed using Eqs. (9) and (10). The values of φ, T, and P determined at each depth from log measurements were used for the database construction. The model parameters were m=2, n=2, Σₘₐₜ=7, Σ_{hc}=22. The graph 76 in FIG. 6 shows the comparison of the water saturation estimated using the RBF mapping function methodology according to an embodiment with the values estimated using a non-linear optimization method. There is overall agreement between the values estimated using the two methodologies. However, the mapping function methodology in accordance with an embodiment may have a relatively short computation time since the estimation is obtained without any iterative optimization.

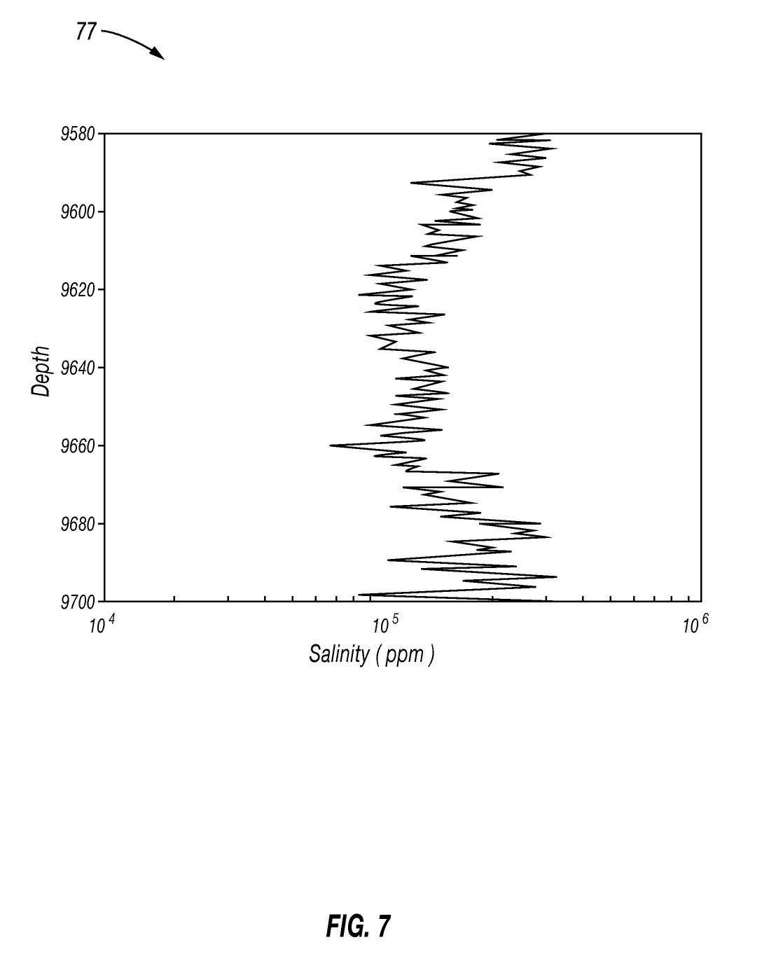

The graph 77 in FIG. 7 illustrates a comparison for water salinity estimated using the RBF mapping function methodology according to an embodiment with the values estimated using an optimization method. Indeed, there is also relative agreement for the estimated values.

The method described herein using the mapping function may provide for visualization of the database 32, for example, to gain petrophysical insights. The database input measurements may be plotted in two or three dimensions for fixed values of the properties of the subterranean formation. The region included within contour lines spanning the possible ranges of the properties of the subterranean formation constitutes the solution space. Subsequently, the log measurements can be superimposed on the contour plot. If the log measurements lie within the solution space, visual interpolation between the contour lines provides a solution of the inverse problem consistent with the response equations. On the other hand, the presence of log measurements outside the solution space indicates either an inappropriate selection of model parameters or errors in the data.

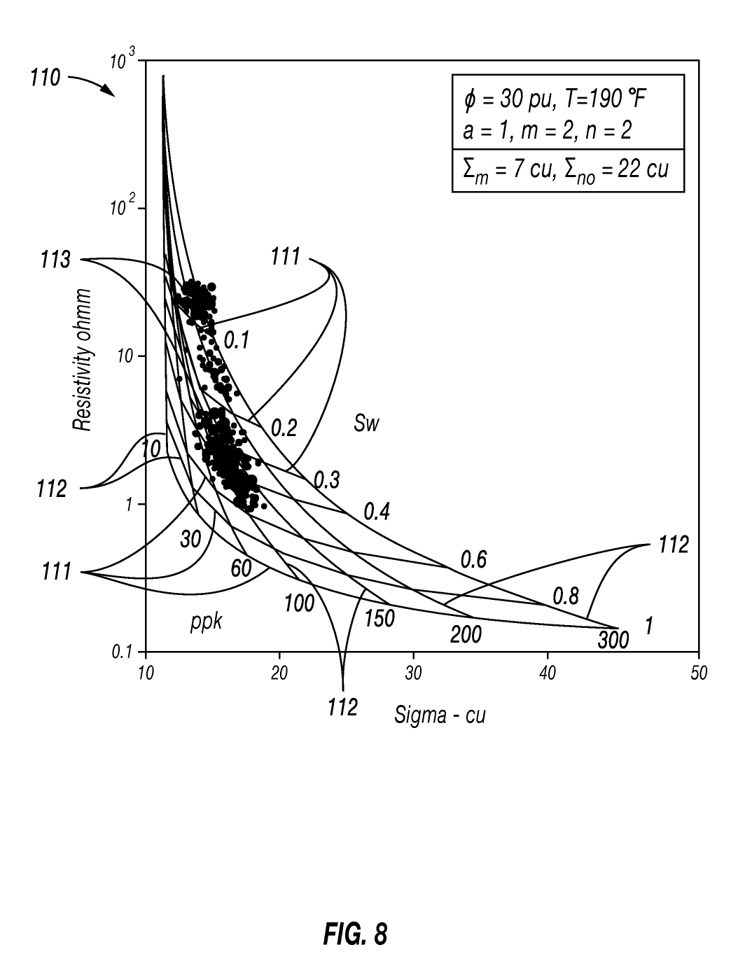

Referring now to the graph 110 in FIG. 8, with respect to the method described herein, in a joint interpretation of resistivity and sigma measurements, the solution space may be represented by the contour lines for fixed values of S_{w} (111) and salinity 112. The parameters used to construct the contour plot are also mentioned in the figure legend. The solution space has a shape of a boomerang which gradually tapers as formation resistivity increases and formation sigma decreases. Therefore, the shape of the solution space provides a relatively clear visual illustration that water saturation and salinity cannot be accurately predicted in regions of high resistivity and low sigma. The dots 113 are log data points. The presence of data points within the solution space confirms the validity of the model parameters. Furthermore, for each data point, a corresponding S_{w} and salinity can be obtained by visual interpolation between the contour lines in the vicinity of the data point.

### EXAMPLE 2

Integration of resistivity, sigma and dielectric measurements. This example involves the application of the method for analyzing a subterranean formation according to an embodiment for joint interpretation of resistivity, sigma, and dielectric measurements to estimate water saturation, salinity, and cementation exponent (m) used in Archie's equation.

The dependence of resistivity and sigma measurements on water saturation, salinity, and porosity is described in Eqs. (9) and (10), above. A model which is frequently used for interpreting downhole dielectric measurements is the complex refractive index model (CRIM). This model states that the complex dielectric permittivity of the formation, ε*, measured at downhole conditions is given as:

\sqrt{ε*}=(1−φ)\sqrt{εₘ}φS_{w}\sqrt{ε_{w}*}+φ(131 S_{w})\sqrt{ε_{hc}} (14)

where εₘ, ε_{w}*, and ε_{hc} are the permittivities of the matrix, water, and hydrocarbon, respectively. Note that the permittivities of matrix and hydrocarbon are real quantities, while the permittivity of water is complex, and is dependent on temperature, dielectric frequency, and salinity. The complex permittivity of water is given by the Debye expression,

$${ɛ}_{w}^{*} = {ɛ}_{∞} + \frac{{ɛ}_{s} - {ɛ}_{∞}}{1 + {( jωτ )}^{1 - α}} - j \frac{σ}{{ωɛ}_{0}} \qquad ( 15 )$$

where ω=2πf is the angular frequency with f in hertz (e.g., f may represent dielectric tool frequency in one embodiment), ε_{∞} is the dielectric constant at infinite frequency, εₛ is the static dielectric constant, σ is the ionic conductivity, α is an empirical parameter, τ is the relaxation time in seconds, and ε₀ is the permittivity of free space. Empirical expressions for εₛ and τ are known to those skilled in the art.

The mapping function relating the subterranean formation properties to be estimated and the log measurements is constructed:

$$\vec{ξ} = \frac{{\sum }_{i = 1}^{N} \vec{{c}_{i}} exp ( - \frac{‖ \vec{{A}_{T}} - \vec{{A}_{T , i}} ‖}{2 {s}_{i}^{2}} )}{{\sum }_{i = 1}^{N} exp ( - \frac{‖ \vec{{A}_{T}} - \vec{{A}_{T , i}} ‖}{2 {s}_{i}^{2}} )} \qquad ( 16 )$$

In this example, the subterranean formation properties to be estimated are,

\vec{86}=(S_{w},sal,m) (17)

and the input vector includes,

\vec{A_{T}}=(Rₜ,Σ,ε,φ,T,P,f) (18)

Note that the quantities φ, T, P, and f may be fixed, and thus may not be included in the input vector.

A database of 400 values of water saturation (0.01≦Sw≦1), salinity (10⁴≦Sal≦10⁵), and m (1.5≦m≦3) was generated. For each combination of saturation, salinity, and m, corresponding values of subterranean formation resistivity, sigma, and permittivity were computed using Eqs. (9), (10) and (14). Porosity, temperature, and pressure were assumed to be fixed. The values were φ=0.3, T=150 oF, P=5000 psi. The model parameters were specified as follows: ε_{∞}=4.9, α=0, εₘ=7.5 (calcite), ε_{hc}=2, n=2, a=1, and f=1.1 GHz. The database was divided into inputs including Rₜ, Σ and ε*, and outputs including water saturation, salinity, and m.

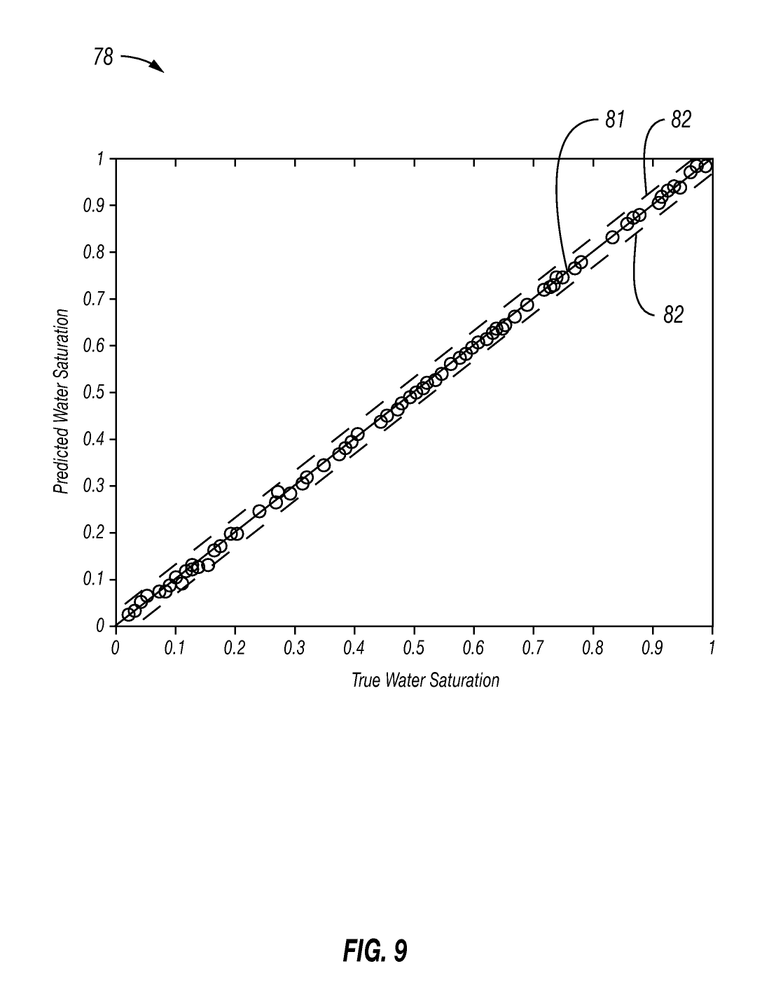

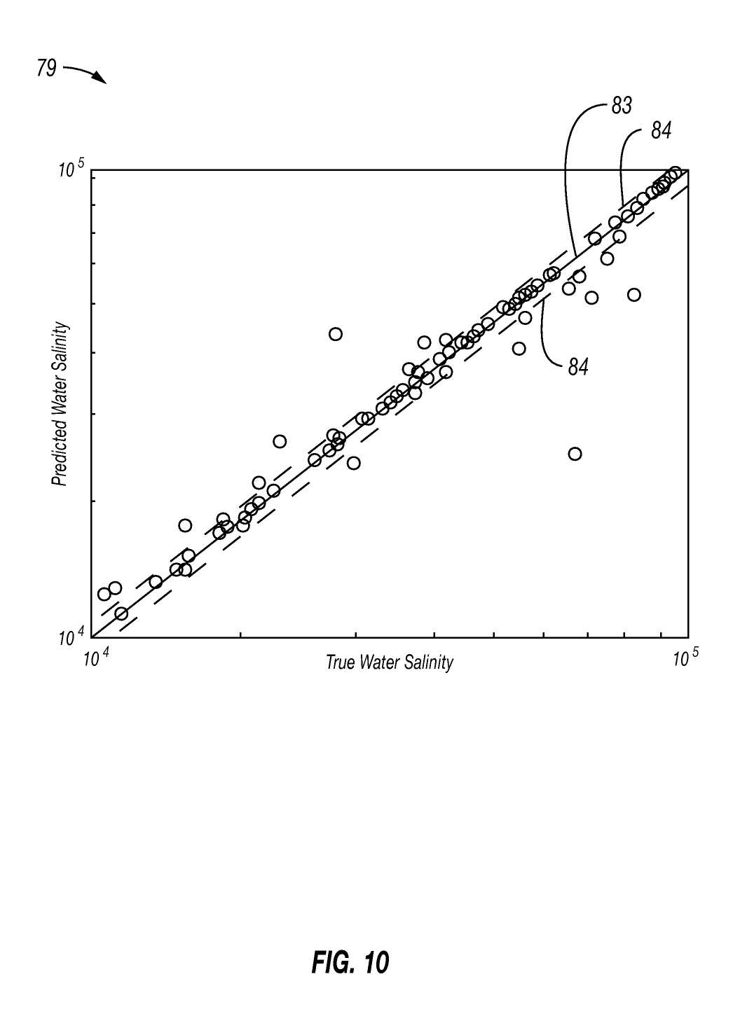

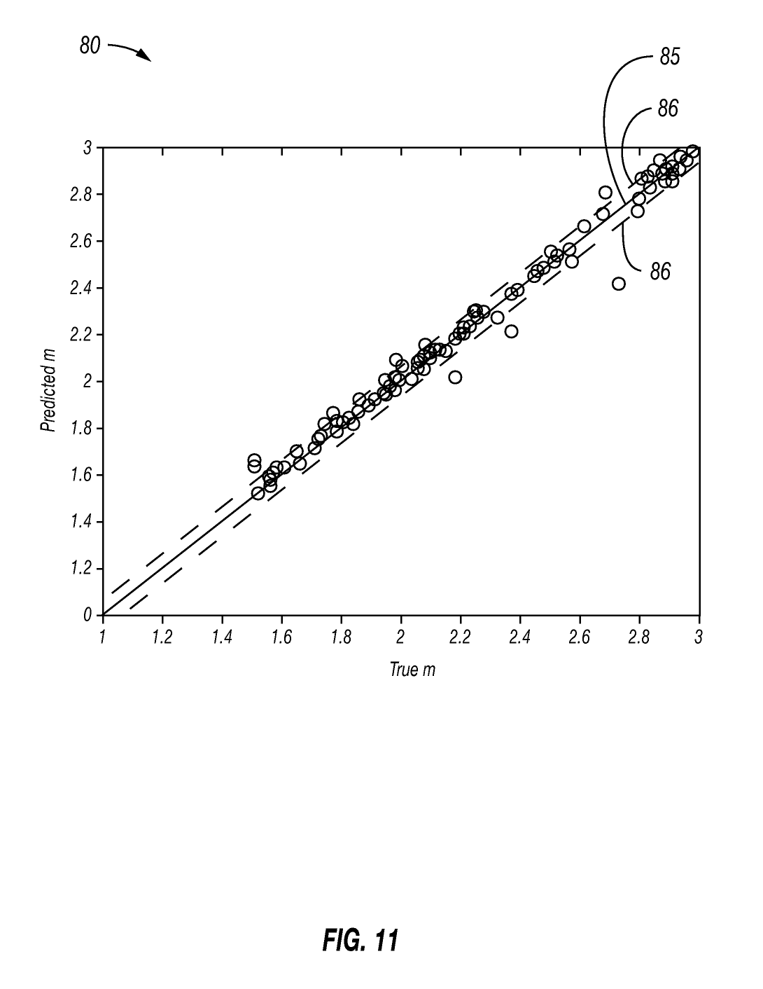

The accuracies of the predictions obtained from the mapping function of Eq. (16) were accessed using the “leave one out” method described above. The widths of the Gaussian RBFs were heuristically determined to be 1.5 times the nearest neighbor distances. The graphs 78, 79, and 80 in FIGS. 9-11, respectively show the comparison of the estimated outputs with the true specified values. The graph 78 in FIG. 9 illustrates a comparison of water saturation estimated from the mapping function with the values in the database. The solid line 81 is a best fit line and the dashed lines 82 are located at ±0.03 deviation. The graph 79 in FIG. 10 illustrates a comparison of water salinity estimated from the mapping function with the values in the database. The solid line 83 is a best fit line and the dashed lines 84 are located at 10% deviation. The graph 80 in FIG. 11 illustrates a comparison of Archie's cementation exponent, m, estimated from the mapping function with the values in the database. The solid line 85 is a best fit line and the dashed lines 86 are located at ±0.1 deviation. The average relative deviations for saturation, salinity, and m are 2.5%, 5.3%, and 1.4% respectively.

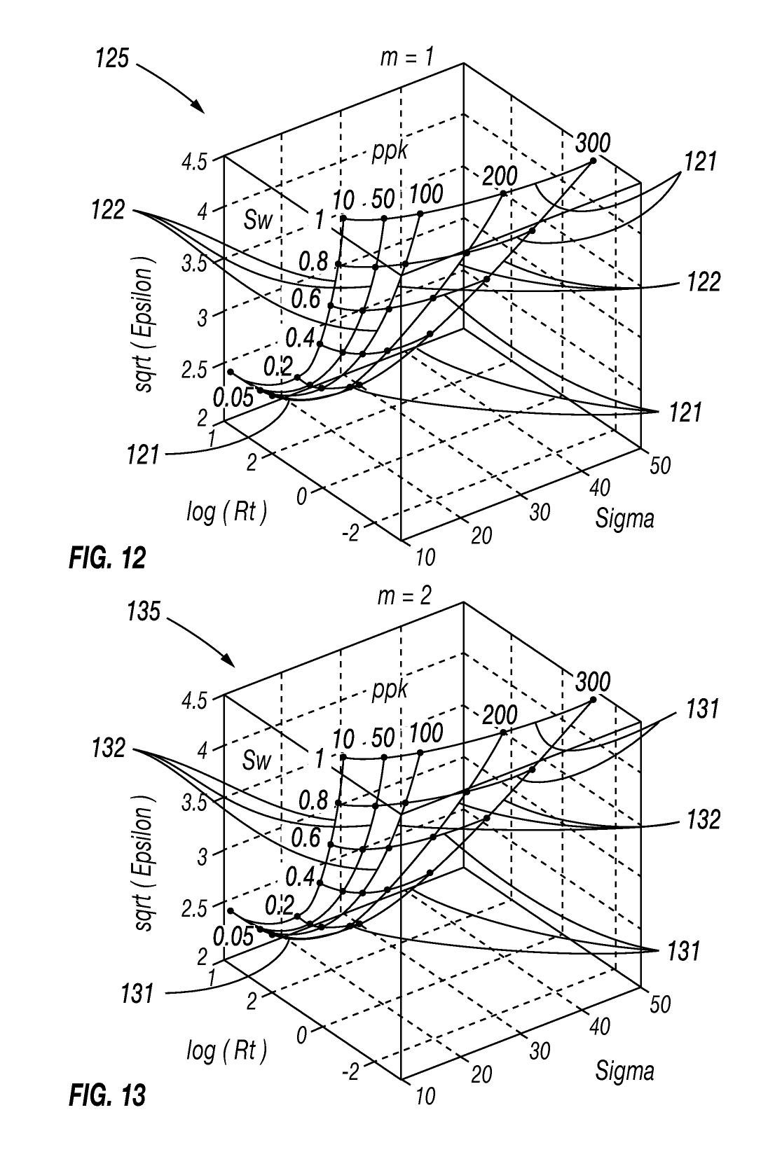

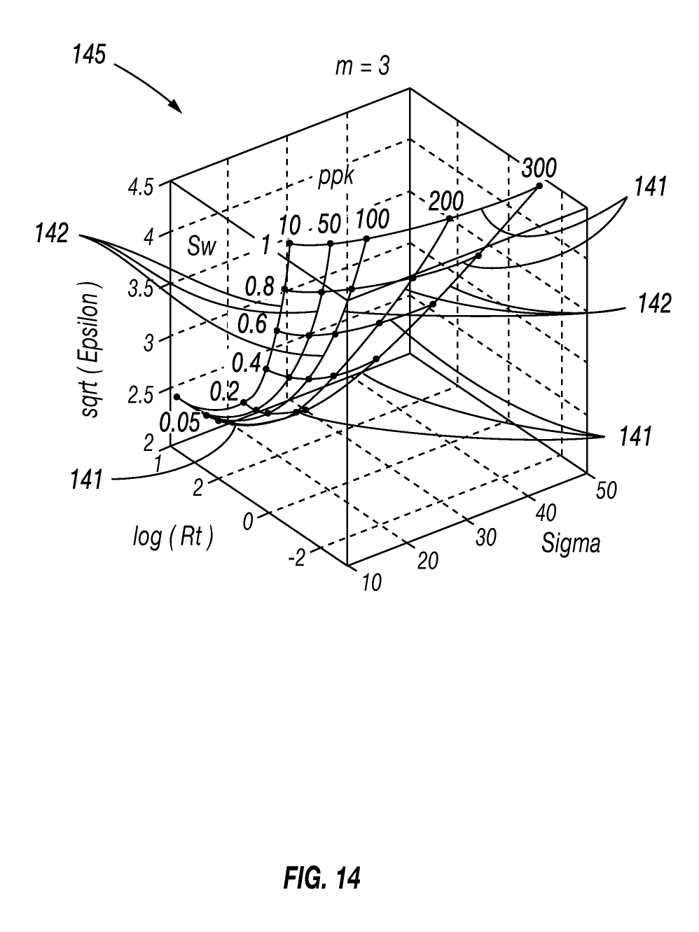

In this example, the solution space can be visualized in three-dimensions as a surface defined by contour lines for fixed values of water saturation and salinity. A family of contour surfaces can be obtained by varying the cementation exponent, m, over the expected range. Referring to the graphs 125, 135, 145, in FIGS. 12-14, respectively, the solution space for three different values of m is illustrated. The 3 dimensions are sigma (x-axis), resistivity (y-axis) and permittivity (z-axis). The contour lines S_{w} 121, 131, 141, and salinity 122, 132, 142 are illustrated for values of m=1, m=2, and m=3, respectively. The superposition of log data on the contour surfaces helps optimize model parameters and obtain a solution consistent with the theoretical response equations.

### EXAMPLE 3

Estimation of anisotropic sand and shale resistivities in thinly-laminated sand shales. With the introduction of 3-D induction logging, it may be possible to independently measure horizontal and vertical subterranean formation resistivities. In a thinly-laminated and anisotropic sand shale sequence, the measured horizontal (Rₕ) and vertical (Rᵥ) resistivities are given by the Generalized Klein-Clavaud equations:

$$\begin{matrix}\frac{{F}_{sh}}{{R}_{sh , h}} + \frac{{F}_{sand}}{{R}_{sand , h}} = \frac{1}{Rh} & ( 19 ) \\ {F}_{sh} {α}_{sh} {R}_{sh , h} + {F}_{sand} {α}_{sand} {R}_{sand , h} = Rv & ( 20 )\end{matrix}$$

where Fₛₕ and F_{sand} are the shale and sand fractions respectively, and Rₛₕ,ₕ, R_{sand},ₕ are the true horizontal shale and sand resistivities. αₛₕ and α_{sand} are the shale and sand anisotropies respectively, defined as:

$$α = \frac{Rv}{Rh} \qquad ( 21 )$$

Although the above system of equations has an analytical solution, this solution involves complex roots and frequently predicts unphysical values.

The RBF mapping function according to the present embodiments, may address unphysical roots, for example. In this case, a mapping function between the desired formation properties, namely Rₛₕ,ₕ and R_{sand},ₕ and outputs including measured Rᵥ and Rₕ was constructed. The parameters F_{sand}, Fₛₕ(=1−F_{sand}), αₛₕ and α_{sand} were assumed to be known.

A database of 100 sand and shale horizontal resistivity values was generated. Sand resistivity varied from 10 to 1000 ohm·m and shale resistivity varied from 0.01 to 1 ohm·m. Sand and shale anisotropies were assumed to be 1 and 3 respectively. For each combination of these values, corresponding values of Rᵥ and Rₕ using Eqs. (19) and (20) was generated.

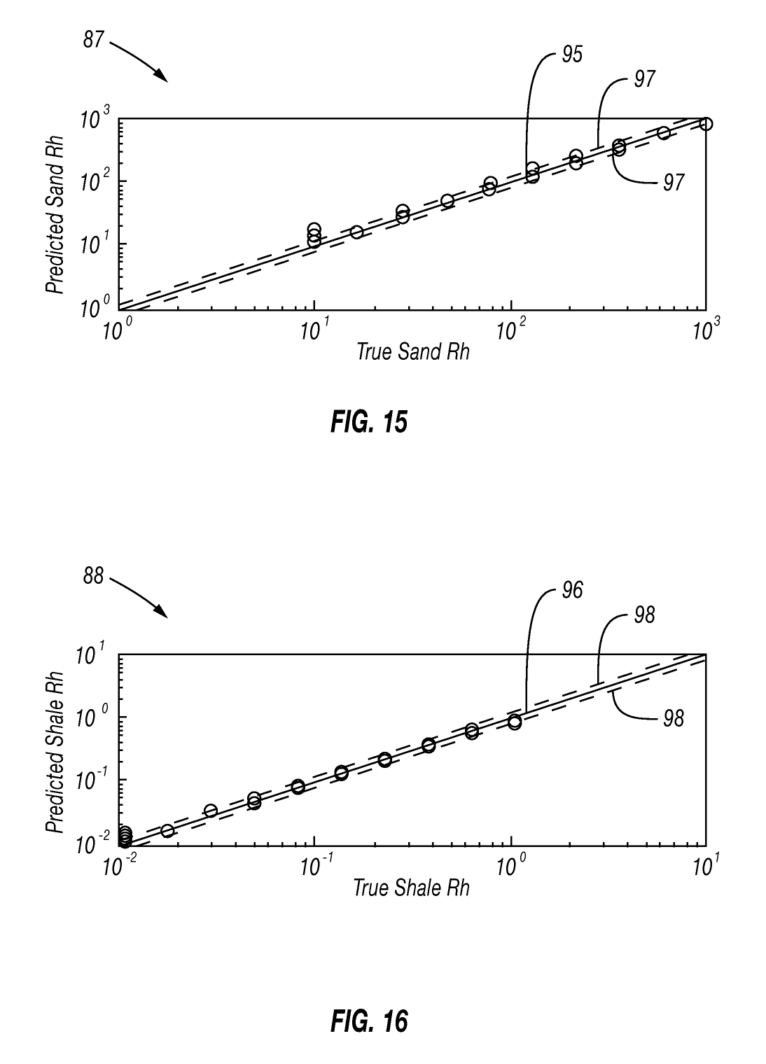

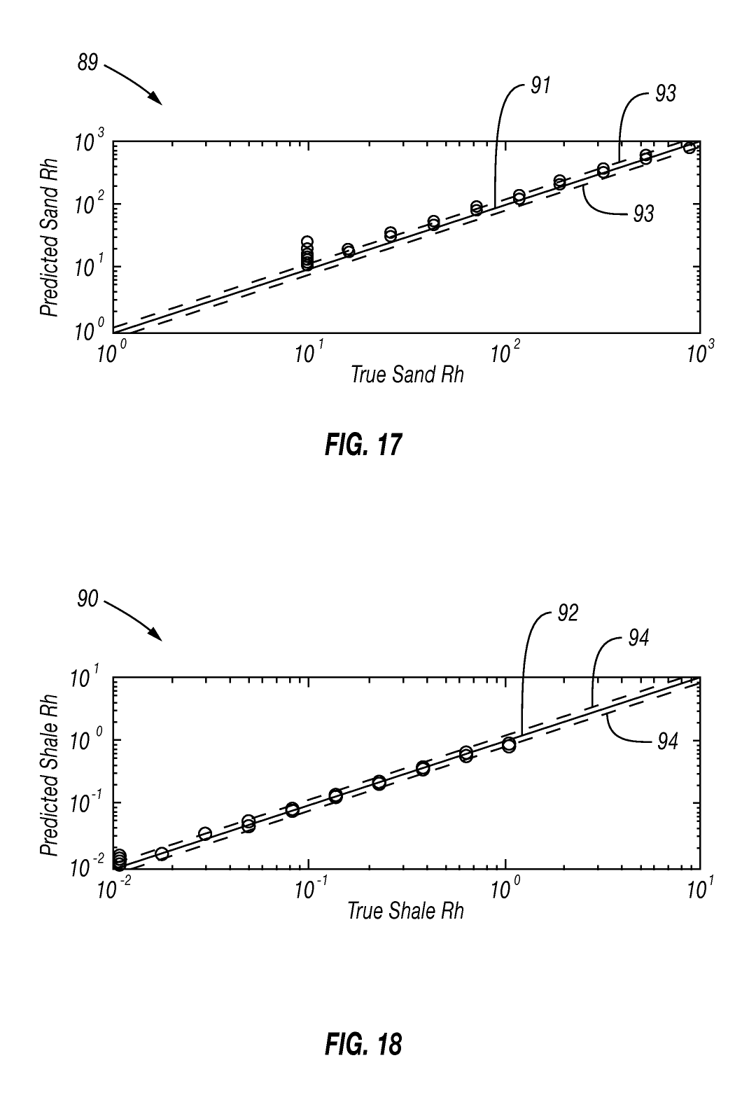

Accuracy of outputs estimated by RBF mapping is quantified using the “leave one out” technique. The comparison between estimated and true sand and shale horizontal resistivities is shown in the graphs 87, 88, 89, 90 in FIGS. 15-18 for two cases: F_{sand}=0.2 and 0.8. FIGS. 15 and 16 illustrate a comparison of sand (FIG. 15) and shale (FIG. 16) horizontal resistivities estimated using the RBF mapping function methodology with the database values F_{sand}=0.2. The solid lines 95, 96 are best fit lines and the dashed lines 97, 98 are 1% deviation for sand and shale, respectively. FIGS. 17 and 18 illustrate a comparison of sand (FIG. 17) and shale (FIG. 18) horizontal resistivities estimated using the RBF mapping function methodology with the database values F_{sand}=0.8. The solid lines 91, 92 are best fit lines and the dashed lines 93, 94 are 1% deviation for sand and shale, respectively.

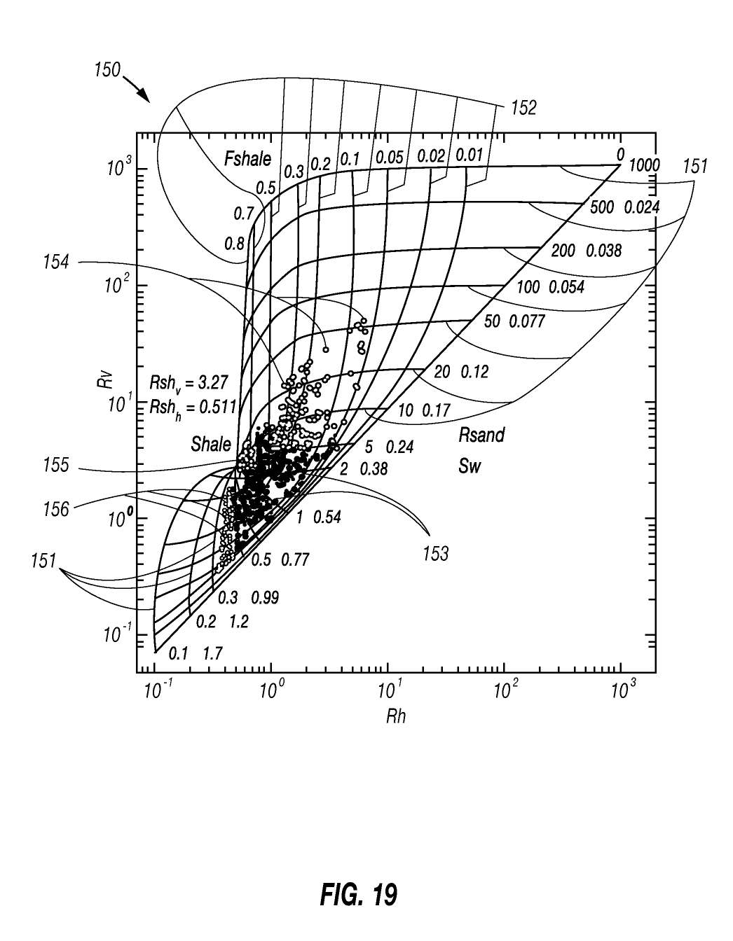

Referring now to the graph 150 in FIG. 19, the database 32 can be visualized to gain petrophysical insights. In this case, it can be represented by contour lines corresponding to fixed values of R_{sand} 151 and Fₛₕ 152. The R_{sand} values are also converted to corresponding S_{w} values using Archie's equation. Pay and non-pay zones can be identified by a S_{w} cutoff The dots 153 are log data points. The points 154 denote the hydrocarbon-bearing thin sands. The points 155 denote the 100% shale points. The points 156 denote the water-bearing points. For each data point, a corresponding R_{sand} and Fₛₕ can be obtained by visual interpolation between contour lines. If the data points lie outside the solution space (graph of R_{sand} and Fₛₕ), then either the data are faulty or the parameters used to build the database (R_{sh,h} and R_{sh,v}) are not adequate.

Additionally, it should be understood that there could be many different ways of implementing the method described herein in computer or algorithmic programming, which should not be limited to any one set of program instructions. Further, a skilled programmer would be able to write such a program to implement one or more of the embodiments based on the flow chart and associated description herein.

The method described herein may be used with computer hardware and software that performs the methods and processing functions described above. Specifically, in describing the functions, methods, and/or steps that can be performed in accordance with the embodiments, any or all of these steps can be performed by using an automated or computerized process. As will be appreciated by those skilled in the art, the systems, methods, and procedures described herein can be embodied in a programmable computer, computer executable software, or digital circuitry. For example, another aspect is directed to a non-transitory computer-readable medium that includes computer-executable instruction for performing the method steps described herein. Examples of readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

While the wellsite system 20 as illustrated for example in FIG. 1 includes a drill string 12, and LWD and MWD modules 120, 130, it should be appreciated that the methods described herein may be applicable to other types of wellsite systems. For example, the methods described herein may apply to tools and toolstrings used in wireline, drill pipe conveyance, wired drill pipe, and/or coiled tubing drilling applications, or other methods of conveyance, in addition.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A method of analyzing a subterranean formation comprising:
collecting a plurality of tool responses from a plurality of different tools;
generating a respective theoretical equation relating tool responses for each of the tools to a plurality of properties of the subterranean formation;
generating a database having the tool responses stored therein based upon each respective theoretical equation;
generating a non-linear mapping function relating at least one of the tool responses to at least one property of the subterranean formation; and
estimating a value for the at least one property based upon the non-linear mapping function.

2. The method of claim 1, wherein the database is generated by at least varying ones of the plurality of properties of the subterranean formation to be estimated over an expected range of values.

3. The method of claim 1, wherein the value is estimated to be consistent with the respective theoretical equation.

4. The method of claim 1, wherein the value is estimated to be consistent with at least one of the tool responses.

5. The method of claim 1, wherein the non-linear mapping function comprises at least one radial basis function.

6. The method of claim 5, wherein the at least one radial basis function comprises at least one Gaussian radial basis function.

7. The method of claim 6, wherein a width of the at least one Gaussian radial basis function is determined based upon adjacent ones of the tool responses stored in the database.

8. The method of claim 1, wherein a coefficient of the non-linear mapping function is generated non-iteratively based upon the database.

9. The method of claim 1, further comprising displaying at least some of the tool responses stored in the database in a plurality of dimensions for the at least one property.

10. A method of analyzing a subterranean formation comprising:
collecting a plurality of tool responses from a plurality of different tools;
generating a respective theoretical equation relating tool responses for each of the tools to a plurality of properties of the subterranean formation;
generating a database having the tool responses stored therein based upon each respective theoretical equation by at least varying ones of the plurality of properties of the subterranean formation to be estimated over an expected range of values;
generating a non-linear mapping function comprising at least one radial basis function relating at least one of the tool responses to at least one property of the subterranean formation; and
estimating a value for the at least one property based upon the non-linear mapping function.

11. The method of claim 10, wherein the value is estimated to be consistent with the respective theoretical equation.

12. The method of claim 10, wherein the value is estimated to be consistent with at least one of the tool responses.

13. The method of claim 10, wherein the at least one radial basis function comprises a Gaussian radial basis function.

14. The method of claim 10, wherein a coefficient of the non-linear mapping function is generated non-iteratively based upon the database.

15. A non-transitory computer-readable medium for analyzing a subterranean formation, the non-transitory computer-readable medium having computer-executable instructions for:
collecting a plurality of tool responses from a plurality of different tools;
generating a respective theoretical equation relating tool responses for each of the tools to a plurality of properties of the subterranean formation;
generating a database having the tool responses stored therein based upon each respective theoretical equation;
generating a non-linear mapping function relating at least one of the tool responses to at least one property of the subterranean formation; and
estimating a value for the at least one property based upon the non-linear mapping function.

16. The non-transitory computer-readable medium of claim 15, wherein the computer-executable instructions are for generating the database by at least varying ones of the subterranean formation properties to be estimated over an expected range of values.

17. The non-transitory computer-readable medium of claim 15, wherein the computer-executable instructions are for estimating the value estimated to be consistent with the respective theoretical equation.

18. The non-transitory computer-readable medium of claim 15, wherein the computer-executable instructions are for estimating the value to be consistent with at least one of the tool responses.

19. The non-transitory computer-readable medium of claim 15, wherein the computer-executable instructions are for generating a non-linear mapping function comprising at least one Gaussian radial basis function.

20. The non-transitory computer-readable medium of claim 19, wherein the at least one radial basis function comprises at least one Gaussian radial basis function.

21. The non-transitory computer-readable medium of claim 15, wherein the computer-executable instructions are for generating a coefficient of the non-linear mapping function non-iteratively based upon the database.

22. The non-transitory computer-readable medium of claim 15, wherein the computer-executable instructions are for displaying at least some of the tool responses stored in the database in a plurality of dimensions for the at least one property.
